(19) United States
(12) Patent Application Publication
(10) Pub. No.: US 2003/0105651 A1
(43) Pub. Date: Jun. 5, 2003

(54) Process for insuring and risk managing the decommissioning and/or abandonment of an oil and gas production facility

(76) Inventor: Edward Gendelman, Littleton, CO (US)

Correspondence Address: Edwin H. Crabtree, Suite 575, 3773 Cherry Creek N. Drive, Denver, CO, 80209, US

(21) Appl. No.: 09/996,497

(22) Filed: Nov. 30, 2001

(51) Int. Cl. G06F 17/60

(52) U.S. Cl. 705/4

(57) ABSTRACT

A process for insuring and risk managing the decommissioning and/or abandonment of an oil and gas production facility such as an off shore oil and gas production platform. The process includes first collecting data related to an oil and gas field and it's production facility from a potential client. Based on the collected data, a model for predicting the production net value profile of the oil and gas field and an estimated time of abandonment is determined. Also, the cost of future decommissioning and abandonment is estimated, the cost of environmental insurance for decommissioning and abandonment is estimated and the cost of transfer of liability insurance is estimated. The three costs are added to estimate a premium to be collected over the life of the oil and gas field. The estimated premium and the field profile model are now used to build a premium payment curve to be paid by the client. At the time of decommissioning and/or abandonment, the insurer pays the oil and gas producer the cost of decommissioning and/or abandonment of the property.

### BACKGROUND OF THE INVENTION

(a) Field of the Invention

This invention relates to the insuring and managing of a future closing of an oil and gas production facility and more particularly, but not by way of limitation, to a process for insuring and managing the risk of decommissioning and/or abandoning an offshore oil and gas production facility.

(b) Discussion of Prior Art

Currently there are several thousand active offshore oil and gas platforms located around the world, with thousands more to come on-stream in the next ten years. The platforms differ in design, size and cost. Also, they are installed in locations with water depth ranging from a few meters to a thousand meters and more. The platforms have one thing in common, that is sooner or later they will be decommissioned and abandoned.

Oil and gas producers face three main risks and liabilities associated with the decommissioning and abandonment of an oil and gas platform. The first is financial wherein large and poorly defined cost is carried as a liability throughout the life of a producing asset thereby reducing its value. The second is environmental where the abandonment of the facility may be improperly conducted. The last is the transfer, where the original owner may, at a later date, inherit back the abandonment liability from an insolvent buyer. Therefore, a large market exists for a risk management and insurance product that will address all of the risks and liabilities mentioned above. The product or process being a form of a “life insurance” for offshore platform, which will allow an oil and gas producer to remove a “P&A” or plug and abandon liability from the producer's balance sheet.

In U.S. Pat. No. 5,202,827 to Sober and U.S. Pat. No. 4,839,804 to Roberts et al. an apparatus for insuring futures contracts against catastrophic losses and insuring the funding of a future liability of a certain cost are described. In U.S. Pat. No. 5,893,072 to Zizzamia a loss control system is described and used with an insurance classification plan. In U.S. Pat. No. 6,254,482 to Walker et al. a system and method used for executing insurance policies related to gambling losses is disclosed. In U.S. Pat. No. 6,018,714 to Risen, Jr. et al.a method of protecting a change in value of intellectual property, such as patents and trademarks is described.

None of the above mentioned prior art patents specifically disclose or teach the unique features, objects and advantages of the subject process for insuring and managing the risk associated with decommissioning and/or abandonment of an oil and gas production facility.

### SUMMARY OF THE INVENTION

In view of the foregoing, it is a primary objective of the subject invention to provide a process for managing and reducing the risk of decommissioning an oil and gas production facility.

Another object of the new process is to insure over the life of an oil and gas producing field the cost of decommissioning and/or abandoning an oil and gas production facility.

Still another object of the invention is to build an insurance premium payment curve based on the estimated net production value curve of the oil and gas field, the time before abandonment and cost of abandonment.

Yet another object of the process is to address the risk of environmental liability associated with abandonment and the risk related to taking back the abandonment liability because of an insolvent buyer of the asset to be abandoned.

A further object of the invention is to remove the “P&A” or plug and abandon liability from the oil and gas producer's balance sheet, in order to release additional capital for productive oil and gas development.

The process includes first collecting data related to an oil and gas field and to its production facility from an oil and gas producer. Based on the collected data, a model is constructed for predicting the net production value profile of the oil and gas field, and an estimated time of abandonment is determined. Also, the cost of fixture decommissioning and abandonment is estimated, the cost of environmental risk insurance for decommissioning and abandoning the operation is estimated and the cost of transfer liability insurance, if any, is established. The three costs are added to estimate a premium to be collected over the life of the oil and gas field. The estimated total premium and the model are now used, together with appropriate discounting and margin considerations, to build a premium payment curve to be paid by the client. The producer then purchases a new insurance policy and at the same time removes the “P&A” liability from their balance sheet. Then during the life of the policy, oil and gas field data is updated and the premium curve is adjusted periodically based on discrepancies between the predicted and actual net value production profile. At the time of decommissioning and/or abandonment, the insurer pays the oil and gas producer the cost of decommissioning and/or abandonment of the property. The process includes an optional step wherein portions of the revenue streams from the premium payments are packaged and securitized for reduction in risks carried by the insurer.

These and other objects of the present invention will become apparent to those familiar with managing an oil and gas production facility and the associated risks and liabilities related to decommissioning and/or abandoning the facility when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments in the present invention according to the best modes presently devised for the practical application of the principles thereof, and in which:

FIG. 1 is a block diagram illustrating the various process steps used in managing and reducing the risk of decommissioning and/or abandoning an oil and gas production facility.

FIG. 2 is an illustration of a premium payment curve and a net production value profile or curve over the life of an oil and gas field prior to the time of an expected abandonment of the production facility.

FIG. 3 illustrates an option wherein portions of revenue streams from the premium payments are packaged and securitized in order to reduce insurer's risk.

### DESCRIPTION OF THE PREFERRED EMBODIMENTS

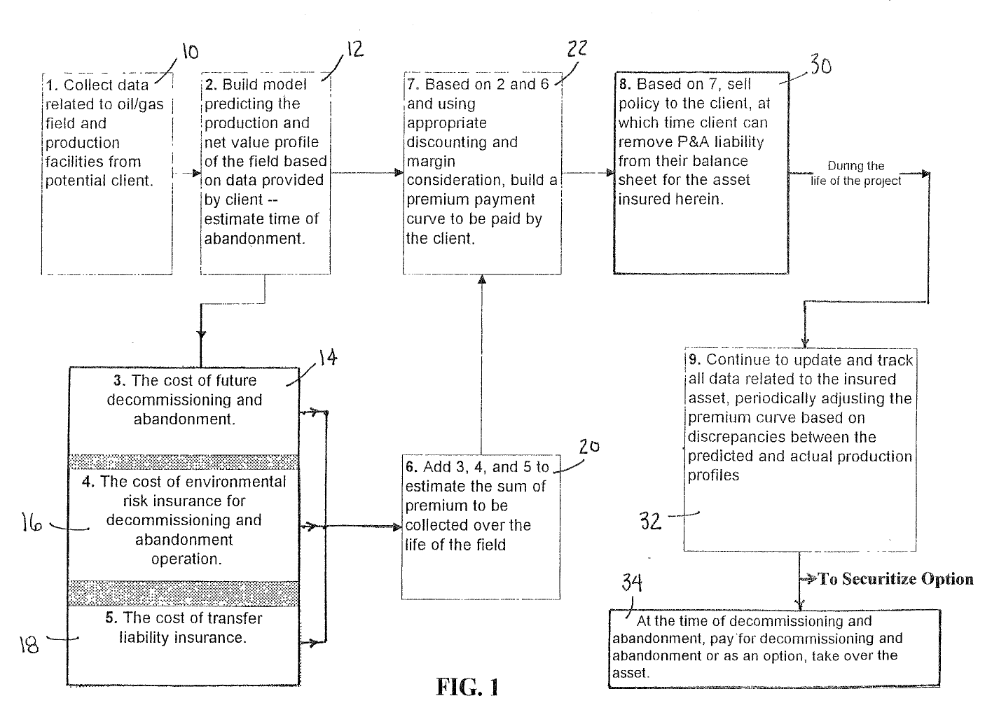

In FIG. 1, a block diagram of the various steps of the subject process for insuring and risk managing the decommissioning and/or abandoning of an oil and gas production facility are illustrated and shown in numbered boxes.

In the first step, shown as box 10, a project management company, such as Oil Exchange, Inc., a Colorado based company, collects engineering and production data related to a selected oil and gas field and to the supporting production facility. For example, the production facility being an off-shore drilling and production platform or like facility.

In the second step, shown as box 12, a model is built from the data collected. The model is used to predict the amount of production of oil and gas, the net production value profile of the field and the estimated life of the field prior to abandoning the production facility.

In the next steps shown as boxes 14, 16 and 18, certain costs are estimated. For example, the cost of future decommissioning and abandonment of the facility is shown in box 14, the cost of environmental risk insurance for decommissioning and abandonment operation is shown in box 16 and the cost of transfer liability insurance related to the facility is shown in box 18.

In box 20, the estimated costs shown in boxes 14, 16 and 18 are added together to estimate the sum of an insurance premium to be collected over the life of the field.

In box 22, the model for predicting the production net value profile of the field, shown in box 12 and the estimated sum of the premium to be collected shown in box 20 are used along with appropriate discounting and margin considerations to build a premium payment curve to be paid by the oil and gas producer.

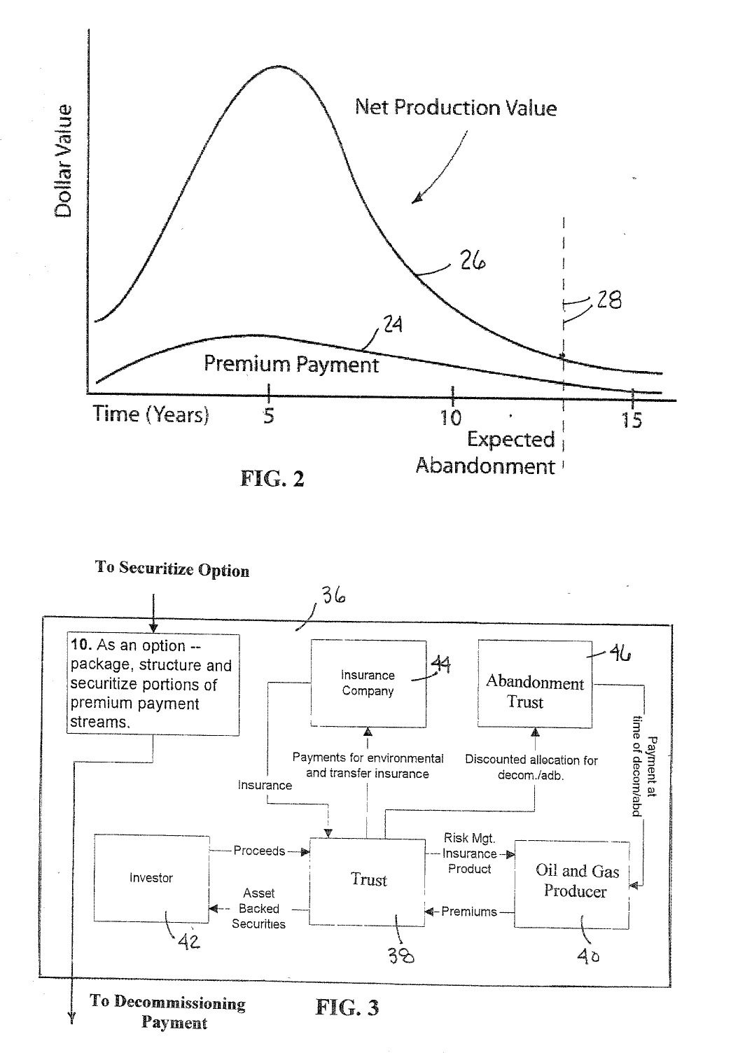

Referring now to FIG. 2, a premium payment curve 24 and a net production value curve 26 is shown over the life of the oil and gas production facility prior to the time of an expected abandonment of the facility. The time of the expected abandonment is shown as vertical dashed line 28. In this example, the expected life of the facility is approximately 13 years before abandonment. The dollar values can be in the millions or billions depending on the size of the oil and gas field and the size and cost of the oil and gas production facility. Using an example of an offshore platform costing 50 million dollars to abandon, the cumulative net production value may be in a range of 1 billion to 2 billion dollars. When viewing the curves 24 and 26, the greatest net production value would be during the 3^{rd} to the 7^{th} year of production, with the value declining after the 7^{th} year. Obviously, the premium payments would be greater during these early peak production years with the payments declining as the production of the field declines and the facility approaches abandonment.

Referring back to FIG. 1, and based on the premium payment curve shown in FIG. 2, the client or oil and gas producer then purchases a new risk management insurance policy and at the same time removes the “P&A” or plug and abandon liability form their balance sheet shown in Box 30.

During the life of the policy, oil and gas field data is updated and the premium payment curve 24 is adjusted periodically, shown in box 32. The adjustment of the curve 24 is based on discrepancies between the predicted and actual net production value profile 26.

At the time of decommissioning and/or abandonment, the insurer pays the oil and gas producer the cost of decommissioning and/or abandonment of the property, as indicated by box 34, or as an option can take over the asset.

The subject process firer includes an optional step, shown in FIG. 3, wherein a portion of the premium payment revenue stream is packaged and securitized for further risk reduction.

In FIG. 3, the optional step of securitzing a portion of the premium payment stream is shown in box 36. In this optional step a trust 38 is formed which receives premiums from the oil and gas producer 40 for the risk management insurance policy mentioned above. The trust 38 then structures and sells asset backed securities to an investor 42. The proceeds paid by the investor 42 for the asset backed securities are then used to make payments to an insurance company 44 for environmental and transfer liability insurance and allocated to an abandonment trust 46. The abandonment trust 46 makes payment to the oil and gas producer 40 for the cost of the decommissioning or abandoning of the facility at the time of abandonment.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which an exclusive privilege and property right is claimed are defined as follows:

1. A process for insuring and risk managing the decommissioning and/or abandoning of an oil and gas production facility owned by an oil and gas producer, the process steps comprising:
collecting engineering and production data related to an oil and gas field and its production facility;
building a model predicting a net production value profile of the oil and gas field using the collected engineering and production data;
estimating future cost of decommissioning and abandoning the oil and gas production facility;
building an insurance premium payment curve to be paid by the oil and gas producer based on the net production value profile and the future cost of decommissioning and abandoning the facility;
selling the oil and gas producer a risk management insurance policy based on an estimated premium payment curve and collecting premium payments from the oil and gas producer; and
paying the oil and gas producer at the time of decommissioning and abandoning the facility for the insured cost of abandonment.

2. The process as described in claim 1 wherein the step of estimating future cost of decommissioning and abandoning the oil and gas facility also includes estimating future cost of environmental risk insurance.

3. The process as described in claim 1 wherein the step of estimating future cost of decommissioning and abandoning the oil and gas facility also includes estimating cost of transfer liability insurance.

4. The process as described in claim 1 further including the step of updating and tracking all data related to the oil and gas field and to the insured production facility during the life of the policy and periodically adjusting the premium payment curve based on discrepancies between the predicted and actual production profile.

5. The process as described in claim 1 wherein at the time of selling the oil and gas producer a risk management insurance policy, the oil and gas producer removes a “P&A” or plug and abandon liability from its balance sheet.

6. The process as described in claim 1 wherein portions of the insurance premium payments received from the oil and gas producer are securitized for further risk reduction.

7. A process for insuring and risk managing the decommissioning and/or abandoning of an oil and gas production facility owned by an oil and gas producer, the process steps comprising:
collecting engineering and production data related to an oil and gas field and its production facility;
building a model predicting a net production value profile of the oil and gas field using the collected engineering and production data;
estimating future cost of decommissioning and abandoning the oil and gas facility, cost of environmental risk insurance and cost of transfer liability insurance;
building an insurance premium payment curve to be paid by the oil and gas producer based on the net production value profile and the future cost of decommissioning and abandoning the facility, the cost of environmental risk insurance and the cost of transfer liability insurance;
selling the oil and gas producer a risk management insurance policy based on an estimated premium payment curve and collecting periodic premium payments from the oil and gas producer, and
paying the oil and gas producer at the time of decommissioning and abandoning the facility for the insured cost of abandonment.

8. The process as described in claim 7 further including the step of updating and tracking all data related to the oil and gas field and to the insured production facility during the life of the policy and periodically adjusting the premium payment curve based on discrepancies between the predicted and actual production profiles.

9. The process as described in claim 7 further including the step of securitizing portions of the insurance premium payments received from the oil and gas producer, for further risk reduction.

10. A process for insuring and risk managing the decommissioning and/or abandoning of an oil and gas production facility owned by an oil and gas producer, the process steps comprising:
collecting engineering and production data related to the oil and gas field and its production facility;
building a model predicting a net production value profile of the oil and gas field using the collected engineering and production data;
estimating future cost of decommissioning and abandoning the oil and gas facility;
building an insurance premium payment curve to be paid by the oil and gas producer based on the net production value profile and the future cost of decommissioning and abandoning the facility;
selling the oil and gas producer a risk management insurance policy based on the estimated premium payment curve, and collecting premium payments from the oil and gas producer;
updating and tracking all data related to the oil and gas field and the insured production facility during the life of the insurance policy and periodically adjusting the premium payment curve based on discrepancies between the predicted and actual production profiles; and
paying the oil and gas producer at the time of decommissioning and abandoning the facility for the insured cost of abandonment.

11. The process as described in claim 10 wherein the step of estimating future cost of decommissioning and abandoning the oil and gas facility also includes estimating future cost of environmental risk insurance.

12. The process as described in claim 10 wherein the step of estimating future cost of decommissioning and abandoning the oil and gas facility also includes estimating cost of transfer liability insurance.

13. The process as described in claim 10 wherein at the time of selling the risk management insurance policy, the oil and gas producer removes a “P&A” or plug and abandon liability from its balance sheet.

14. The process as described in claim 10 wherein a portion of the insurance premium payments received from the oil and gas producer are securitized for further risk reduction.

15. The process as described in claim 10 further including establishing a trust for receiving the insurance premium payments from the oil and gas producer, for the purpose of selling asset backed securities to an investor.
